(19) United States
(12) Patent Application Publication
(10) Pub. No.: US 2026/0357706 A1
(43) Pub. Date: Nov. 12, 2026

(54) TURBINE BLADE

(71) Applicant: MITSUBISHI HEAVY INDUSTRIES, LTD., Tokyo (JP)

(72) Inventors: Taku HIRAYAMA, Tokyo (JP); Satoshi MIZUKAMI, Tokyo (JP); Yusuke AKADA, Tokyo (JP)

(21) Appl. No.: 19/515,031

(22) PCT Filed: Sep. 3, 2024
(86) PCT No.: PCT/JP2024/031522

§ 371 Date: Feb. 27, 2026

(30) Foreign Application Priority Data
Sep. 4, 2023 (JP) 2023-143156

(51) Int. Cl. F01D 5/18; F01D 9/02

(52) U.S. Cl. CPC F01D 5/18; F01D 9/02; F05D 2240/12; F05D 2260/20

(57) ABSTRACT

This turbine blade comprises a blade wall, and an insert inserted into a space formed inside the blade wall. An internal cavity communicating with the outside of the turbine blade is formed inside the insert body portion of the insert. A plurality of ridges protruding toward the inner surface of the blade wall and having a facing surface facing the inner surface of the blade wall are formed on the outer surface of the insert body portion. Each of the plurality of ridges has a flow path communicating with the internal cavity, and a plurality of cooling holes that communicate with the flow path, are open on the facing surface, and are arranged along the longitudinal direction of each of the plurality of ridges. A recovery space is defined between adjacent two ridges out of the plurality of ridges

### TECHNICAL FIELD

The present disclosure relates to a turbine blade.

The present application claims priority based on Japanese Patent Application No. 2023-143156 filed in Japan on Sep. 4, 2023, the contents of which are incorporated herein by reference.

### BACKGROUND ART

PTL 1 discloses a turbine blade that can be cooled by impingement cooling. In the turbine blade, an insert is provided in a space formed inside a blade wall, a plurality of ridges are formed in the insert, to protrude toward an inner surface of the blade wall, and a cooling hole for jetting a cooling medium is formed at a distal end of each ridge. The blade wall can be cooled by collision of the cooling medium jetted from the cooling hole with the inner surface of the blade wall. The cooling medium colliding with the inner surface of the blade wall flows through a recovery space defined between adjacent ridges and is then discharged to an outside of the turbine blade.

In a case where a phenomenon in which the cooling medium flows in a direction along the inner surface between the insert and the inner surface of the blade wall after the cooling medium collides with the inner surface of the blade wall, that is, a crossflow occurs, there is a concern that cooling efficiency of the blade wall is reduced due to interference of the cooling medium jetted from the cooling hole by the crossflow. Meanwhile, in the turbine blade disclosed in PTL 1, the crossflow can be reduced by allowing the cooling medium to flow through the recovery space after the cooling medium collides with the inner surface of the blade wall.

### CITATION LIST

### Patent Literature

[PTL 1] Japanese Unexamined Patent Application Publication No. 2015-63997

### SUMMARY OF INVENTION

### Technical Problem

However, in a case where the plurality of ridges extend to a shroud, since the cooling medium flowing through the recovery space has to flow out from the inside of the blade wall through a narrow gap between the plurality of ridges and the inner surface of the blade wall, there is a problem in that it is difficult for the cooling medium to flow out from the inside of the blade wall.

In view of the above circumstances, an object of at least one embodiment of the present disclosure is to provide a turbine blade in which a cooling medium that has cooled a blade wall is made to easily flow out from the inside of the blade wall.

### Solution to Problem

In order to achieve the above object, a turbine blade according to the present disclosure includes a blade wall, and an insert that is inserted into a space formed inside the blade wall, in which an internal cavity that communicates with an outside of the turbine blade is formed inside an insert body portion of the insert, a plurality of ridges that protrude toward an inner surface of the blade wall and that have facing surfaces facing the inner surface of the blade wall are formed on an outer surface of the insert body portion, each of the plurality of ridges is formed with a flow path that communicates with the internal cavity, and a plurality of cooling holes that communicate with the flow path, are open at the facing surface, and are arranged along a longitudinal direction of each of the plurality of ridges, a recovery space is defined between two adjacent ridges of the plurality of ridges, a recovery flow path that communicates with the recovery space is defined between the outer surface of the insert body portion and the inner surface of the blade wall and, in the longitudinal direction, between a hub-side edge of the blade wall and an end portion of the ridge on a hub side, or between a tip-side edge of the blade wall and an end portion of the ridge on a tip side, and a discharge hole that communicates the recovery flow path with the outside of the turbine blade is formed in the blade wall.

### Advantageous Effects of Invention

According to the turbine blade of the present disclosure, since the cooling medium flowing through each recovery space converges in the recovery flow path and flows out from the recovery flow path through the discharge hole, the cooling medium that has cooled the blade wall can be made to easily flow out from the inside of the blade wall.

### BRIEF DESCRIPTION OF DRAWINGS

FIG. 1 is a schematic configuration diagram of a gas turbine according to all embodiments of the present disclosure.

FIG. 2 is a view in which a turbine blade according to Embodiment 1 of the present disclosure is viewed in a direction from a pressure surface toward a negative pressure surface.

FIG. 3 is a cross-sectional view taken along line III-III in FIG. 2.

FIG. 4 is a cross-sectional view taken along line IV-IV in FIG. 2.

FIG. 5 is an enlarged cross-sectional view of a part of an insert of the turbine blade according to Embodiment 1 of the present disclosure.

FIG. 6 is a perspective view for describing a configuration of a plurality of ridges of the insert of the turbine blade according to Embodiment 1 of the present disclosure.

FIG. 7 is a cross-sectional view of a part of the insert and a blade wall of the turbine blade according to Embodiment 1 of the present disclosure.

FIG. 8 is a perspective view showing a configuration of a part of a modification example of the ridges of the insert of the turbine blade according to Embodiment 1 of the present disclosure.

FIG. 9 is a front view showing a configuration of a part of ridges of an insert of a turbine blade according to Embodiment 2 of the present disclosure.

FIG. 10 is a front view showing a configuration of a part of ridges of an insert of a turbine blade according to Embodiment 3 of the present disclosure.

FIG. 11 is a cross-sectional view of ridges of an insert of a turbine blade according to Embodiment 4 of the present disclosure.

FIG. 12 is a cross-sectional view of another aspect of the ridges of the insert of the turbine blade according to Embodiment 4 of the present disclosure.

FIG. 13 is a front view showing a configuration of a part of ridges of an insert of a turbine blade according to Embodiment 5 of the present disclosure.

FIG. 14 is a front view showing a configuration of a part of a modification example of the ridges of the insert of the turbine blade according to Embodiment 5 of the present disclosure.

FIG. 15 is a front view showing a configuration of a part of another modification example of the ridges of the insert of the turbine blade according to Embodiment 5 of the present disclosure.

FIG. 16 is a cross-sectional view of a part of a blade wall and an insert of a turbine blade according to Embodiment 6 of the present disclosure.

FIG. 17 is a cross-sectional view of a part of another aspect of the insert of the turbine blade according to Embodiment 6 of the present disclosure.

FIG. 18 is a cross-sectional view of a part of still another aspect of the insert of the turbine blade according to Embodiment 6 of the present disclosure.

FIG. 19 is a cross-sectional view of a part of a portion corresponding to a cross section taken along line III-III in FIG. 2 in a modification example of the turbine blade according to Embodiment 6 of the present disclosure.

### DESCRIPTION OF EMBODIMENTS

Hereinafter, a turbine blade according to embodiments of the present disclosure will be described with reference to the drawings. The embodiments which will be described below represent aspects of the present disclosure and do not limit the disclosure, and any change can be made within the scope of the technical idea of the present disclosure.

### Configuration Common to All Embodiments of Present Disclosure

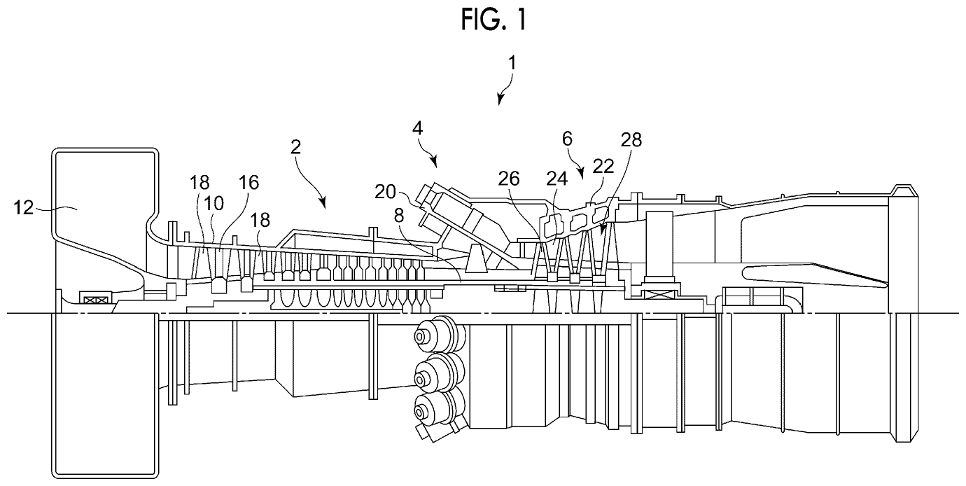

As shown in FIG. 1, a gas turbine 1 includes a compressor 2 for generating compressed air, a combustor 4 for generating combustion gas using the compressed air and fuel, and a turbine 6 configured to be rotationally driven by the combustion gas. In a case of the gas turbine 1 for power generation, a generator (not shown) is connected to the turbine 6.

The compressor 2 includes a plurality of stator vanes 16 fixed to a compressor casing 10 side and a plurality of rotor blades 18 attached to a rotor 8. Air taken in from an air intake port 12 is fed to the compressor 2. The air passes through the plurality of stator vanes 16 and the plurality of rotor blades 18, and is compressed to be high-temperature and high-pressure compressed air.

The combustor 4 is configured to be supplied with the fuel and the compressed air generated by the compressor 2, and the fuel and the compressed air are mixed and then combusted in the combustor 4 to generate combustion gas that is an operating fluid for the turbine 6. A plurality of combustors 4 may be disposed in a casing 20 along a circumferential direction around the rotor.

The turbine 6 includes a combustion gas passage 28 formed in a turbine casing 22, and a plurality of stator vanes 24 and a plurality of rotor blades 26 provided in the combustion gas passage 28. The stator vanes 24 are fixed on the turbine casing 22 side, and a plurality of stator vanes 24 arranged along the circumferential direction of the rotor 8 constitute a stator vane row. Further, the rotor blade 26 is attached to the rotor 8, and a rotor blade row is configured with the plurality of rotor blades 26 arranged along the circumferential direction of the rotor 8. Stator vane rows and rotor blade rows are alternately arranged in an axial direction of the rotor 8.

### Embodiment 1

### <Configuration of Turbine Blade According to Embodiment 1 of Present Disclosure>

The turbine blade according to Embodiment 1 of the present disclosure is applied to both the stator vane 24 and the rotor blade 26 of the turbine 6. Hereinafter, a turbine blade according to Embodiment 1 of the present disclosure will be described as the stator vane 24, but it may also be the rotor blade 26.

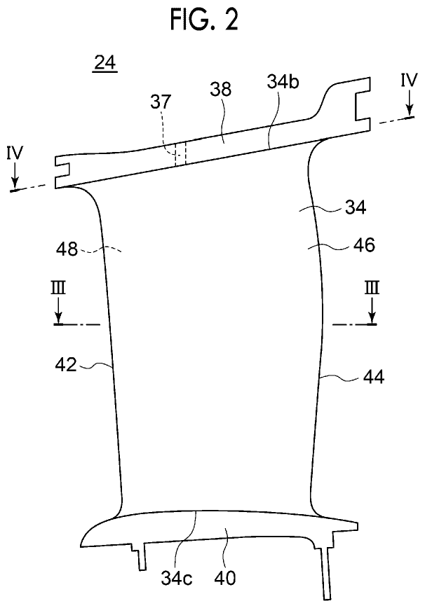

As shown in FIG. 2, the stator vane 24 includes a blade wall 34, and the blade wall 34 extends in a direction from a hub-side edge 34c toward a tip-side edge 34b, that is, in a blade height direction of the stator vane 24. An outer shroud 38 and an inner shroud 40 are provided on the tip-side edge 34b and the hub-side edge 34c, respectively. Here, the term “hub side” means a rotation axis center side in a radial direction of a rotation path of the rotor blade 26 (see FIG. 1), and the term “tip side” means an outer peripheral side of the rotation path in the radial direction of the rotation path of the rotor blade 26. Accordingly, the hub-side edge 34c and the tip-side edge 34b correspond to the end edge on the hub side and the end edge on the tip side of both end edges in the blade height direction of the stator vane 24 in the above-described meanings, respectively. The blade wall 34 has a leading edge 42 and a trailing edge 44 extending along the blade height direction, and has a pressure surface 46 and a negative pressure surface 48 extending between the leading edge 42 and the trailing edge 44.

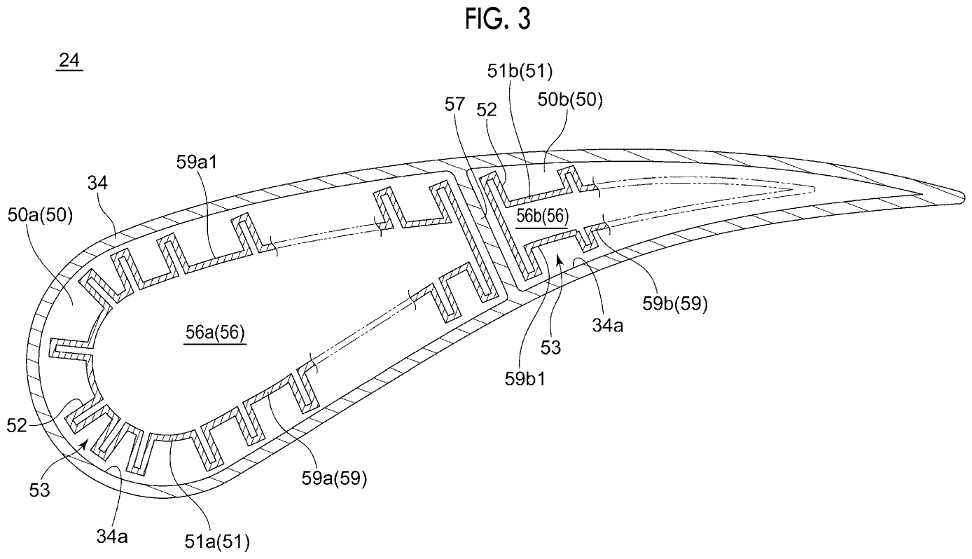

As will be described later, a space 50 (see FIG. 3) is formed inside the blade wall 34, and a path 37 that communicates the outside of the stator vane 24 with an internal cavity 56 (see FIG. 3), which will be described later, of an insert 51 (see FIG. 3) provided in the space 50 is formed in the outer shroud 38. The path 37 is not limited to the form in which the path 37 is formed in the outer shroud 38, and may be formed in the inner shroud 40. In FIG. 2, the path 37 is schematically shown as being provided as one path, but may be provided in a plurality. The role of the path 37 will be described later.

As shown in FIG. 3, the space 50 is formed inside the blade wall 34. The space 50 may be divided by a partition wall 57 into a plurality of spaces, for example, two spaces 50a and 50b. The space 50 may be divided into three or more spaces by two or more partition walls 57, or the space 50 may be set as one space without providing the partition wall 57. An insert 51 is inserted into the space 50. As shown in FIG. 3 as an example, in a case where the space 50 is divided into two spaces 50a and 50b, the insert 51 may include inserts 51a and 51b inserted into each space.

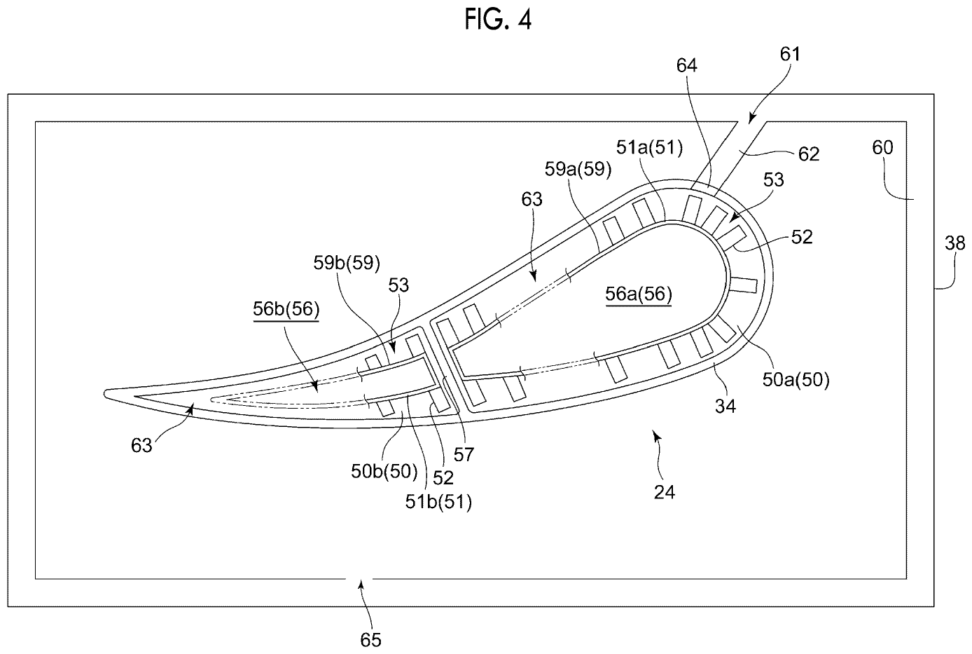

As shown in FIG. 4, a shroud peripheral flow path 60 is formed along a peripheral edge of the outer shroud 38. A supply port 61 is formed at any position of the shroud peripheral flow path 60, and one end of a supply path 62 is connected to the supply port 61. As will be described later, each of the inserts 51a and 51b includes a plurality of ridges 52 that are formed to extend along the blade height direction of the stator vane 24, that is, along a direction perpendicular to the paper plane in FIG. 4. In the space 50 inside the blade wall 34, a recovery space 53 is defined between each of the adjacent ridges 52 and 52, and a recovery flow path 63 communicating with each recovery space 53 is defined. A discharge hole 64 that communicates the recovery flow path 63 with the outside of the blade wall 34 is formed in the blade wall 34, and the other end of the supply path 62 is connected to the discharge hole 64. That is, the recovery flow path 63 and the shroud peripheral flow path 60 communicate with each other through the discharge hole 64, the supply path 62, and the supply port 61. A discharge port 65 that communicates with the outside of the blade wall 34 is formed at any position different from the supply port 61 in the shroud peripheral flow path 60. The shroud peripheral flow path 60 may be formed in the shroud on the side where the path 37 is not provided, that is, the inner shroud 40 (see FIG. 2) in the above-described configuration, instead of the outer shroud 38.

### <Configuration of Insert>

As shown in FIG. 3, the insert 51 (51a and 51b) includes a tubular insert body portion 59 (59a and 59b) having a longitudinal axis along the blade height direction (direction perpendicular to the paper plane in FIG. 3) of the stator vane 24, and an internal cavity 56 (56a and 56b) is formed inside the insert body portion 59 (59a and 59b). The internal cavity 56 (56a and 56b) communicates with the path 37 (see FIG. 2). A plurality of ridges 52 that protrude toward an inner surface 34a of the blade wall 34 are formed on respective outer surfaces 59a1 and 59b1 of the insert body portions 59a and 59b. In each of the inserts, the plurality of ridges 52 extend along the blade height direction of the stator vane 24 and are formed to be arranged at an interval in the circumferential direction around the longitudinal axis. In each of the inserts, the recovery space 53 is defined between the adjacent ridges 52 and 52 in the circumferential direction around the longitudinal axis.

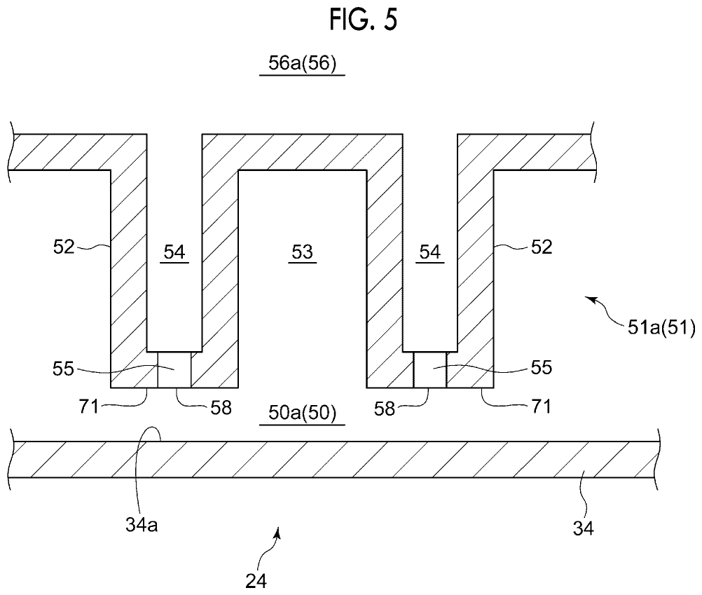

Next, the configuration of the ridges 52 will be described. FIG. 5 is a cross-sectional view of some of the plurality of ridges 52 provided in the insert 51a. The configuration of the ridges 52 described below with reference to FIG. 5 also applies to all or some of the plurality of ridges 52 provided in the other insert 51b.

A flow path 54, which is a cavity communicating with the internal cavity 56a, is formed inside the ridge 52. In addition, a plurality of cooling holes 55 that communicate with the flow path 54 and that are open to face the inner surface 34a of the blade wall 34 are formed in the ridges 52 (in FIG. 5, one cooling hole 55 of the plurality of cooling holes 55 in each ridge 52 is shown).

The ridges 52 may be disposed at equal intervals to uniformly cool the entire stator vane 24, or the interval between the adjacent ridges 52 and 52 at a portion to be specifically cooled may be smaller than the interval between the adjacent ridges 52 and 52 at other portions. For example, the interval between the ridges 52 and 52 disposed on a front side of the stator vane 24 may be smaller than the interval between the ridges 52 and 52 disposed on a rear side of the stator vane 24. Further, the ridges 52 disposed on each of the front side and the rear side of the stator vane 24 may be disposed such that the interval between the adjacent ridges 52 and 52 gradually increases from a leading edge toward a trailing edge of the stator vane 24.

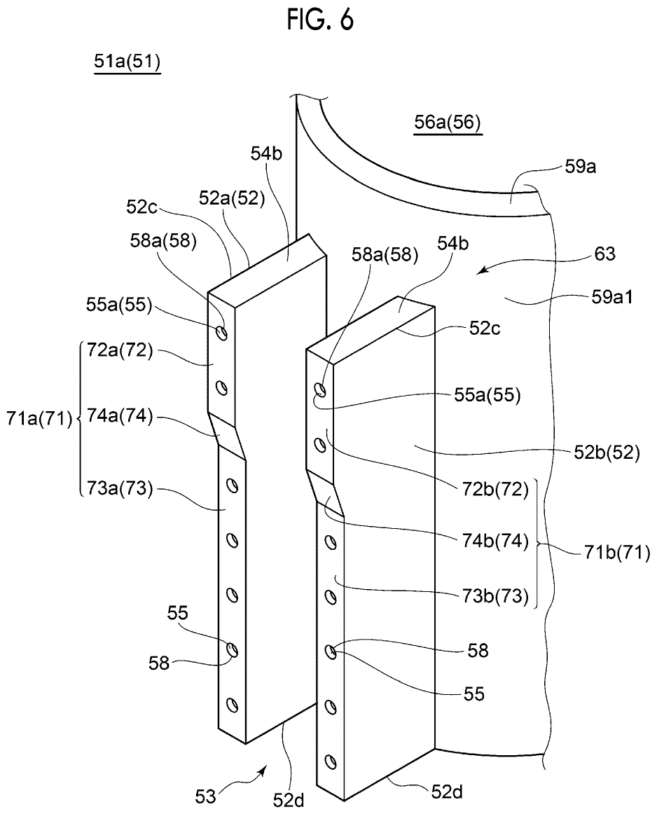

FIG. 6 shows any two adjacent ridges 52a and 52b. The configuration described below also applies to other adjacent ridges other than the ridges 52a and 52b. Each of the ridges 52a and 52b has a shape like a rail that protrudes toward the inner surface 34a (see FIG. 3) of the blade wall 34 and extends along the blade height direction of the stator vane 24, has an end portion 52c on the tip side and an end portion 52d on the hub side, and has facing surfaces 71 (71a and 71b) facing the inner surface 34a. In Embodiment 1, the facing surfaces 71 are divided into a first region 72 (72a and 72b) and a second region 73 (73a and 73b). A boundary region 74 (74a and 74b) connecting the first region 72 and the second region 73 is provided between the first region 72 and the second region 73.

Openings 58 of the plurality of cooling holes 55 are formed in the facing surfaces 71 to be arranged in a row in a longitudinal direction (direction in which the ridges 52 extend along the blade height direction of the stator vane 24 as described above) of the ridges 52. The number of cooling holes 55 (same meaning as an opening 58a formed in each facing surface 71) formed in each ridge 52 is arbitrary. In addition, the interval between the adjacent cooling holes 55 and 55 may be equal to each other or different from each other. In the latter configuration, for example, the interval between the adjacent cooling holes 55 and 55 may gradually increase from the hub side toward the tip side, or conversely, the interval between the adjacent cooling holes 55 and 55 may gradually increase from the tip side toward the hub side.

FIG. 6 shows a configuration in which two openings 58 are formed in the first region 72 and five openings 58 are formed in the second region 73, but this configuration is merely an exemplary configuration. The opening 58 of at least one cooling hole 55 is formed in the first region 72. The “opening 58 of at least one cooling hole 55” formed in the first region 72 is the opening 58a of a first cooling hole 55a formed at a position closest to the recovery flow path 63 in the longitudinal direction of the ridges 52, that is, a position closest to the discharge hole 64 (see FIG. 4).

In the first region 72, the opening 58a of at least the first cooling hole 55a may be formed, and the number of openings 58 formed in the first region 72 is arbitrary. For example, in the first region 72, two openings including the opening 58a and one opening 58 located adjacent to the opening 58a may be formed (corresponding to the configuration of FIG. 6), or three openings including the opening 58a and two openings 58 located adjacent to the opening 58a may be formed. The openings other than the openings formed in the first region 72 are formed in the second region 73. That is, the openings 58 are not formed in the boundary region 74.

The number of openings 58 formed in each of the first region 72 and the second region 73 depends on the interval between the adjacent openings 58 and 58 and the length of each of the first region 72 and the second region 73 in the longitudinal direction of the ridges 52, but the number of openings formed in the first region 72 is smaller than the number of openings formed in the second region 73, and the length of the first region 72 is smaller than the length of the second region 73 in the longitudinal direction of the ridges 52. The length of the first region 72 is preferably smaller than half of the length of the ridges 52, more preferably smaller than ⅓ of the length of the ridges 52, and most preferably smaller than ¼ of the length of the ridges 52.

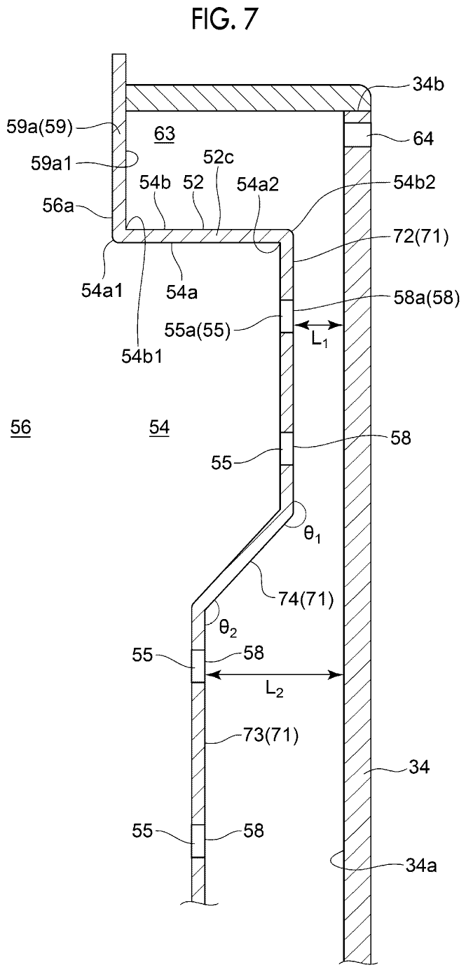

As shown in FIG. 7, the first region 72 is configured to protrude toward the inner surface 34a of the blade wall 34 more than the second region 73. That is, a distance L₁ from the opening 58 formed in the first region 72 to the inner surface 34a is smaller than a distance L₂ from the opening 58 formed in the second region 73 to the inner surface 34a. In a case where an angle formed by the boundary region 74 with respect to the first region 72 is denoted by θ₁, and an angle formed by the boundary region 74 with respect to the second region 73 is denoted by θ₂, a range of the angle θ₁ is 180°<θ₁≤270°, and a range of the angle θ₂ is 90°≤θ₂<180°.

In the configuration of FIG. 7, since the discharge hole 64 is formed near the tip-side edge 34b of the blade wall 34, the recovery flow path 63 is defined between the outer surface 59a1 of the insert body portion 59a and the inner surface 34a of the blade wall 34 and between the tip-side edge 34b of the blade wall 34 and the end portion 52c of the ridge 52 on the tip side in the longitudinal direction of the ridge 52. In a case where the discharge hole 64 is formed near the hub-side edge 34c (see FIG. 2) of the blade wall 34, the recovery flow path 63 is defined between the outer surface 59a1 of the insert body portion 59a and the inner surface 34a of the blade wall 34 and between the hub-side edge 34c of the blade wall 34 and the end portion 52d (see FIG. 6) of the ridge 52 on the hub side in the longitudinal direction.

An outer surface 54b of the end portion 52c facing the recovery flow path 63 includes a first connection edge 54b1 connected to the outer surface 59a1 of the insert body portion 59a and a second connection edge 54b2 connected to the facing surface 71. The first connection edge 54b1 and the second connection edge 54b2 are located at positions away from the tip-side edge 34b toward the hub-side edge 34c (see FIG. 2) of the blade wall 34 in the longitudinal direction of the ridge 52, and the outer surface 54b is a flat surface. With this configuration, the recovery flow path 63 is formed between the tip-side edge 34b and the end portion 52c in the longitudinal direction of the ridge 52. The first connection edge 54b1 may be at the same position as the tip-side edge 34b in the longitudinal direction. That is, at least the second connection edge 54b2 out of the first connection edge 54b1 and the second connection edge 54b2 may be located at a position away from the tip-side edge 34b toward the hub-side edge 34c of the blade wall 34 in the longitudinal direction of the ridge 52.

### <Cooling Operation of Blade Wall in Turbine Blade According to Embodiment 1 of Present Disclosure>

A cooling operation of the blade wall in the turbine blade according to Embodiment 1 of the present disclosure will be described. As shown in FIG. 2, a cooling medium (for example, cooling air) is supplied from the outside of the stator vane 24 to the inside of the blade wall 34 through the path 37. As shown in FIG. 3, the cooling medium flows into each of the internal cavities 56a and 56b inside the blade wall 34. For example, the cooling medium that flows into the internal cavity 56a flows into the flow path 54 as shown in FIG. 5, then flows into the cooling hole 55, and is jetted from the opening 58 toward the inner surface 34a of the blade wall 34. The cooling medium jetted from the cooling hole 55 collides with the inner surface 34a of the blade wall 34, so that the blade wall 34 is cooled. The cooling medium collides with the inner surface 34a of the blade wall 34 and is then introduced into the recovery space 53 defined between the adjacent ridges 52 and 52.

As shown in FIG. 4, the cooling medium introduced into the recovery space 53 flows through the recovery space 53 toward the recovery flow path 63 and flows from the recovery space 53 into the recovery flow path 63. The cooling medium flowing through each recovery space 53 converges in the recovery flow path 63 and flows out from the recovery flow path 63 through the discharge hole 64. The cooling medium flowing out from the recovery flow path 63 flows through the supply path 62 and then flows into the shroud peripheral flow path 60 through the supply port 61. The cooling medium flowing into the shroud peripheral flow path 60 flows through the shroud peripheral flow path 60 and then flows out from the shroud peripheral flow path 60 to the outside of the stator vane 24 through the discharge port 65.

After the cooling medium collides with the inner surface 34a of the blade wall 34, when a phenomenon occurs in which the cooling medium flows in a direction along the inner surface 34a in a vicinity of another opening 58, that is, a crossflow, there is a concern that cooling efficiency is reduced due to interference of the cooling medium jetted from the other opening 58 by the crossflow. However, in the stator vane 24 having the above-described configuration, the cooling medium is introduced into the recovery space 53 after colliding with the inner surface 34a of the blade wall 34. Therefore, the crossflow can be reduced, and as a result, it is possible to suppress a concern that the cooling efficiency of the blade wall 34 is reduced.

However, in the above-described configuration, in a case where the crossflow that is not introduced into the recovery space 53 is present, the crossflow locally increases in a region close to the discharge hole 64 in the longitudinal direction of the ridge 52 due to the flow of the cooling medium in the recovery flow path 63 flowing out from the discharge hole 64 to the outside of the blade wall 34. Then, the cooling medium jetted from the opening 58 of the cooling hole 55 in the region close to the discharge hole 64 in the longitudinal direction of the ridge 52 is interfered with by the locally large crossflow (for example, the flow of the jetted cooling medium is deflected), so that the cooling efficiency of the blade wall 34 is reduced.

On the other hand, in Embodiment 1, as shown in FIG. 7, in each ridge 52, the distance L₁ from the opening 58 formed in the first region 72 to the inner surface 34a is smaller than the distance L₂ from the opening 58 formed in the second region 73 to the inner surface 34a. As a result, in the region close to the discharge hole 64 in the longitudinal direction of the ridge 52, that is, in the first region 72, the distance L₁ from the opening 58 to the inner surface 34a is small, so that the cooling medium jetted from the opening 58 in the first region 72 can collide with the inner surface 34a of the blade wall 34 before the flow of the cooling medium is deflected by the crossflow. That is, since the influence of the flow of the cooling medium jetted from the opening 58 in the first region 72 being deflected by the crossflow can be suppressed, the adverse effect of the locally large crossflow on the cooling effect of the blade wall 34 can be suppressed.

The crossflow flowing in a direction toward the first region 72 between the second region 73 and the inner surface 34a of the blade wall 34 collides with the boundary region 74, changes a flow direction to a direction along the boundary region 74, and flows into the recovery spaces 53 (see FIGS. 3 to 6) on both sides of the ridge 52. As a result, since the crossflow flowing into a space between the first region 72 and the inner surface 34a of the blade wall 34 is reduced, the influence of the crossflow on the flow of the cooling medium jetted from the opening 58 in the first region 72 can be weakened. In addition, since the cooling medium flowing through each recovery space 53 converges in the recovery flow path 63 and flows out from the recovery flow path 63 through the discharge hole 64, the cooling medium that has cooled the blade wall 34 can be made to easily flow out from the inside of the blade wall 34.

### <Modification Example of Turbine Blade According to Embodiment 1 of Present Disclosure>

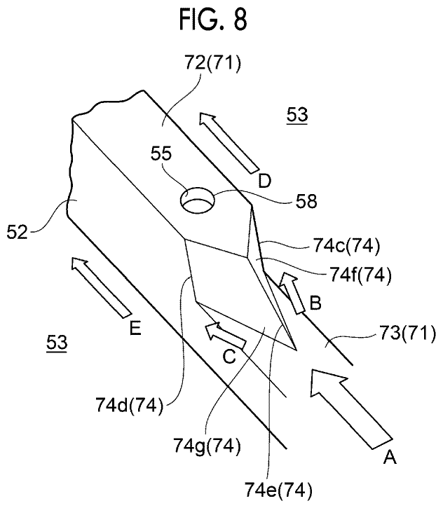

In Embodiment 1, the boundary region 74 is a flat surface, but may be a curved surface that is curved to be recessed toward the first region 72. In addition, as shown in FIG. 8, the boundary region 74 may have a configuration in which the boundary region 74 protrudes from both end edges 74c and 74d of the boundary region 74 in a direction (width direction of the ridge 52) orthogonal to the longitudinal direction of the ridge 52 toward the second region 73. In this configuration, the boundary region 74 has a protruding edge 74e between the end edge 74c and the end edge 74d in the width direction of the ridge 52, and has a first surface 74f and a second surface 74g on both sides of the protruding edge 74e in the width direction of the ridge 52. In a case where the boundary region 74 has such a configuration, the crossflow flowing along the second region 73 toward the boundary region 74 (in a direction of an arrow A) collides with the protruding edge 74e to be divided into flows (arrows B and C) on both sides of the protruding edge 74e. One of the divided crossflows (arrow B) flows along the first surface 74f, and the other (arrow C) flows along the second surface 74g, so that the crossflows flow into the recovery spaces 53 and 53 on both sides of the ridge 52 (arrows D and E). As a result, since the crossflow flowing into a space between the first region 72 and the inner surface 34a of the blade wall 34 is reduced, the influence of the crossflow on the flow of the cooling medium jetted from the opening 58 in the first region 72 can be weakened.

### Embodiment 2

Next, the turbine blade according to Embodiment 2 of the present disclosure will be described. Although Embodiment 2 is described as a configuration independent of the configuration of Embodiment 1, Embodiment 2 may have a configuration described below on the premise of the configuration of Embodiment 1and the modification example thereof. Further, in Embodiment 2, the same components as those in Embodiment 1 are designated by the same reference signs, and the detailed descriptions thereof will be omitted.

### <Configuration of Turbine Blade According to Embodiment 2 of Present Disclosure>

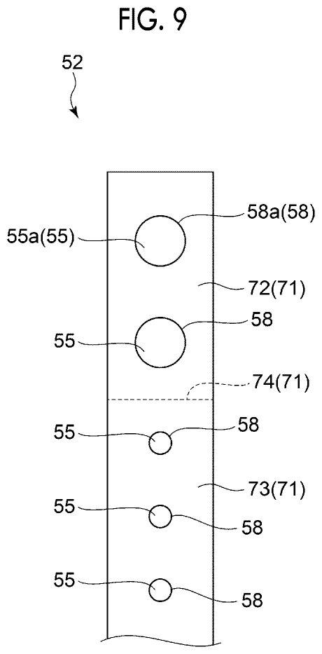

As shown in FIG. 9, in the first region 72 of the facing surface 71 of the ridge 52, the opening 58a of the first cooling hole 55a and the opening 58 located adjacent to the opening 58a are formed as in the exemplary configuration of Embodiment 1. The number of the openings 58 in the first region 71 is not limited to two, which is the same as in Embodiment 1. In Embodiment 2, the first region 72 may not protrude toward the inner surface 34a (see FIGS. 3 to 5) of the blade wall 34 more than the second region 73, and the first region 72 and the second region 73 may constitute the same plane (as described above, the configuration of Embodiment 1 and the modification example thereof may be adopted), but in this configuration, the boundary region 74 is a boundary line extending in the width direction of the ridge 52, instead of a surface as in Embodiment 1.

In Embodiment 2, the opening area of each opening 58 formed in the first region 72 is larger than the opening area of each opening 58 formed in the second region 73. In FIG. 9, the opening 58 is shown as a circular shape, but the opening 58 is not limited to the circular shape, and may be an elliptical shape that is long in the longitudinal direction or the width direction of the ridge or a direction between the longitudinal direction and the width direction, or may be any shape such as a polygonal shape or an irregular shape. In addition, the shapes of all the openings may not be the same as each other, and at least some of the openings may have different shapes.

### <Cooling Operation of Blade Wall in Turbine Blade According to Embodiment 2 of Present Disclosure>

The cooling operation of the blade wall in the turbine blade according to Embodiment 2 of the present disclosure is essentially the same as in Embodiment 1.As an operation different from Embodiment 1, since the opening area of the opening 58 formed in the first region 72 is larger than the opening area of the opening 58 formed in the second region 73, the flow rate of the cooling medium jetted from the opening 58 in the first region 72 is larger than the flow rate of the cooling medium jetted from the opening 58 in the second region 73. As a result, even in a case where there is a concern that the crossflow flowing between the first region 72 and the inner surface 34a may be locally large and the cooling efficiency of the blade wall 34 may be reduced, since the concern of the reduction in the cooling efficiency can be compensated for by the increase in the flow rate of the cooling medium jetted toward the inner surface 34a facing the first region 72, the adverse effect of the locally large crossflow on the cooling effect of the blade wall 34 can be suppressed.

In Embodiment 1, in response to the local increase in the crossflow between the first region 72 and the inner surface 34a of the blade wall 34, the distance between the first region 72 and the inner surface 34a is reduced so that the cooling medium jetted from the opening 58 in the first region 72 can collide with the inner surface 34a before being deflected by the crossflow. In Embodiment 2, the opening area of the opening 58 formed in the first region 72 is increased to increase the flow rate of the jetted cooling medium, so that the concern of the reduction in the cooling efficiency of the blade wall 34 due to the locally large crossflow is compensated for. On the other hand, in the configuration of Embodiment 2, since the flow of the cooling medium jetted from the opening 58 in the first region 72 has a larger cross-sectional area of the flow cut in a direction orthogonal to the flow direction than the flow of the cooling medium jetted from the opening 58 in the second region 73 due to the difference in the opening area between the opening 58 in the first region 72 and the opening 58 in the second region 73, the effect in which the flow of the cooling medium jetted from the opening 58 in the first region 72 is less likely to be deflected by the crossflow can be obtained. The above-described effect of Embodiment 1 and the latter effect of the two effects of Embodiment 2 are common in that the cooling medium jetted from the opening 58 in the first region 72 is less likely to be deflected by the crossflow until the cooling medium collides with the inner surface 34a. Such an effect can be appropriately obtained by adjusting an index described below.

A ratio L₁/D₁ of a diameter Di converted from the opening area of the opening 58 in a case where the opening 58 formed in the first region 72 is regarded as a circular shape and a distance L₁ (see FIG. 7) from the opening 58 formed in the first region 72 to the inner surface 34a of the blade wall 34 may be adjusted as the above-described index. Specifically, the ratio L₁/D₁ may be smaller than the same ratio L₂/D₂ for the opening 58 formed in the second region 73 (D2 is a diameter converted from the opening area of the opening 58 in a case where the opening 58 formed in the second region 73 is regarded as a circular shape). By controlling such a ratio, in a case where both the opening area of the opening 58 and the distance from the opening 58 to the inner surface 34a are different between the first region 72 and the second region 73, a configuration in which the above-described effect can be reliably obtained can be designed.

### Embodiment 3

Next, the turbine blade according to Embodiment 3 of the present disclosure will be described. Although Embodiment 3 is described as a configuration independent of the configurations of Embodiments 1 and 2, Embodiment 3 may have a configuration described below on the premise of the configurations of Embodiments 1 and 2 and the modification examples thereof. Further, in Embodiment 3, the same components as those in Embodiments 1 and 2 are designated by the same reference signs, and the detailed descriptions thereof will be omitted.

### <Configuration of Turbine Blade According to Embodiment 3 of Present Disclosure>

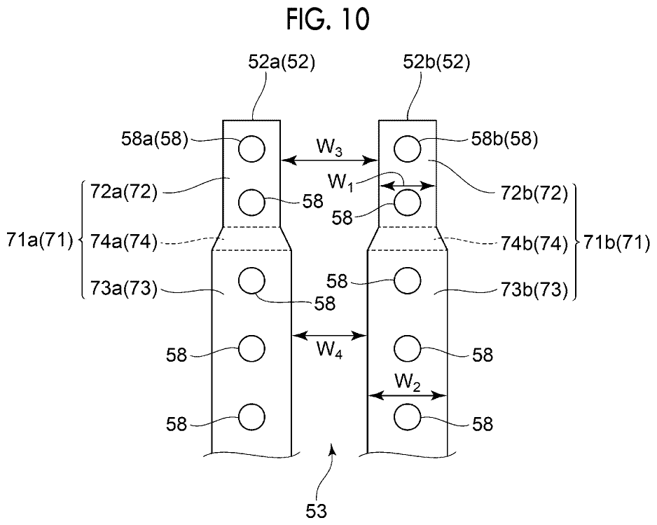

As shown in FIG. 10, in the ridge 52, a width W₁ of the ridge 52 in the first region 72 is smaller than a width W₂ of the ridge 52 in the second region 73. As a result, a width W₃ of the recovery space 53 formed between the first regions 72a and 72b is larger than a width W₄ of the recovery space 53 formed between the second regions 73a and 73b.

### <Cooling Operation of Blade Wall in Turbine Blade According to Embodiment 3 of Present Disclosure>

The cooling operation of the blade wall in the turbine blade according to Embodiment 3 of the present disclosure is essentially the same as in Embodiment 1. As an operation different from Embodiment 1, since the width W₃ of the recovery space 53 formed between the first regions 72a and 72b is larger than the width W₄ of the recovery space 53 formed between the second regions 73a and 73b, the crossflow is more likely to flow into the recovery space 53 in a case where the crossflow flows between the first region 72 and the inner surface 34a of the blade wall 34 than in a case where the crossflow flows between the second region 73 and the inner surface 34a (see FIGS. 3 to 5) of the blade wall 34. Due to such a difference, since the crossflow flowing between the first region 72 and the inner surface 34a of the blade wall 34 can be reduced, the adverse effect of the locally large crossflow on the cooling effect of the blade wall 34 can be suppressed.

### Embodiment 4

Next, the turbine blade according to Embodiment 4 of the present disclosure will be described. Although Embodiment 4 is described as a configuration independent of the configurations of Embodiments 1 to 3, Embodiment 4 may have a configuration described below on the premise of the configurations of Embodiments 1 to 3 and the modification examples thereof. Further, in Embodiment 4, the same components as those in Embodiments 1 to 3 are designated by the same reference signs, and the detailed descriptions thereof will be omitted.

### <Configuration of Turbine Blade According to Embodiment 4 of Present Disclosure>

L₁/D₁ As shown in FIG. 11, in the first region 72 of the ridge 52, both end edges 71c and 71d of the facing surface 71 in the width direction of the ridge 52 are chamfered. A range in which both end edges 71c and 71d are chamfered may be at least the first region 72, but the boundary region 74 (see FIGS. 6 and 7) and the second region 73 (see FIGS. 6 and 7) may also be chamfered. That is, both end edges of the ridge 52 may be chamfered. The form of the chamfering is not limited to a form in which the cross section is chamfered into a curved shape as shown in FIG. 11, and may be a form in which the cross section is chamfered into a linear shape as shown in FIG. 12.

### <Cooling Operation of Blade Wall in Turbine Blade According to Embodiment 4 of Present Disclosure>

L₁/D₁ The cooling operation of the blade wall in the turbine blade according to Embodiment 4 of the present disclosure is essentially the same as in Embodiment 1.As an operation different from Embodiment 1, since both end edges 71c and 71d of the facing surface 71 in the width direction of the ridge 52 in the first region 72 are chamfered, the crossflow flowing between the first region 72 and the inner surface 34a of the blade wall 34 is more likely to flow into the recovery space 53 than in a case where both end edges 71c and 71d are not chamfered. Due to such a difference, since the crossflow flowing between the first region 72 and the inner surface 34a of the blade wall 34 can be reduced, the adverse effect of the locally large crossflow on the cooling effect of the blade wall 34 can be suppressed.

### Embodiment 5

Next, the turbine blade according to Embodiment 5 of the present disclosure will be described. Although Embodiment 5 is described as a configuration independent of the configurations of Embodiments 1 to 4, Embodiment 5 may have a configuration described below on the premise of the configurations of Embodiments 1 to 4 and the modification examples thereof. Further, in Embodiment 5, the same components as those in Embodiments 1 to 4 are designated by the same reference signs, and the detailed descriptions thereof will be omitted.

### <Configuration of Turbine Blade According to Embodiment 5 of Present Disclosure>

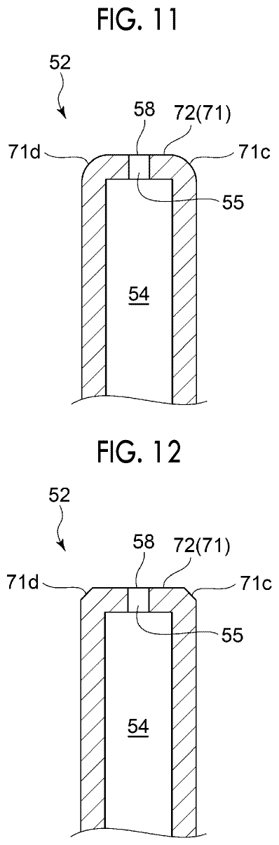

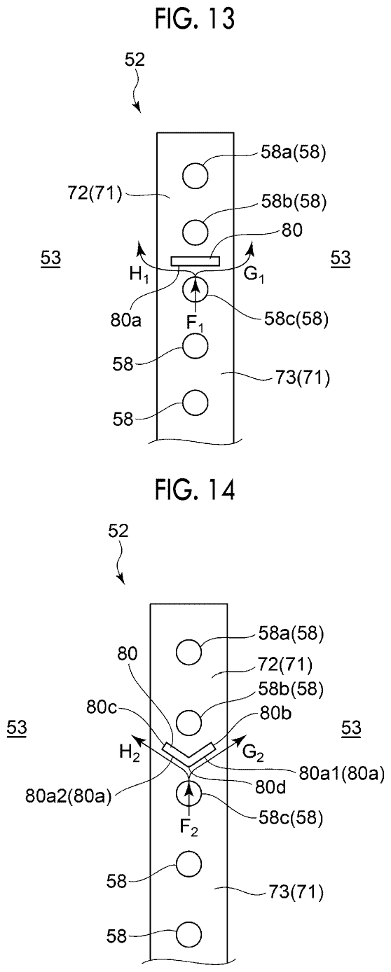

As shown in FIG. 13, in the ridge 52, an opening formed at a position farthest from the discharge hole 64 (see FIG. 4) in the longitudinal direction of the ridge 52 among the openings 58 in the first region 72 is defined as an opening 58b, and an opening formed at a position closest to the discharge hole 64 in the longitudinal direction of the ridge 52 among the openings 58 in the second region 73 is defined as an opening 58c. In a case where only one opening 58a is formed in the first region 72, the opening 58a is defined as the opening 58b. A rectangular and plate-shaped protrusion 80 is provided between the opening 58b and the opening 58c on the facing surface 71 of the ridge 52. The plate-shaped protrusion 80 has a surface 80a facing the first region 72 when viewed from the second region 73 in the longitudinal direction of the ridge 52. In a case where the protrusion 80 is rectangular and plate-shaped, the surface 80a is preferably perpendicular to both the facing surface 71 and the longitudinal direction of the ridge 52, but is not limited to being strictly perpendicular, and may be approximately perpendicular.

### <Cooling Operation of Blade Wall in Turbine Blade According to Embodiment 5 of Present Disclosure>

The cooling operation of the blade wall in the turbine blade according to Embodiment 5 of the present disclosure is essentially the same as in Embodiment 1. As an operation different from Embodiment 1, the crossflow flowing in a direction (arrow F₁) toward the first region 72 between the second region 73 and the inner surface 34a of the blade wall 34 collides perpendicularly with the surface 80a. In a case where the crossflow collides perpendicularly with the surface 80a, the crossflow changes the flow direction in a direction (arrows Gi and H1) along the surface 80a after colliding with the surface 80a, and flows into the recovery spaces 53 on both sides of the ridge 52. As a result, since the crossflow flowing into a space between the first region 72 and the inner surface 34a of the blade wall 34 is reduced, the influence of the crossflow on the flow of the cooling medium jetted from the opening 58 in the first region 72 can be weakened. As a result, the adverse effect of the locally large crossflow on the cooling effect of the blade wall 34 can be suppressed.

### <Modification Example of Turbine Blade According to Embodiment 5 of Present Disclosure>

The protrusion 80 is not limited to the rectangular shape and plate shape. The protrusion 80 may have any shape as long as the protrusion 80 has a shape having the surface 80a facing the first region 72 when viewed from the second region 73 in the longitudinal direction of the ridge 52. The term “facing” is not limited to being perpendicular to the longitudinal direction of the ridge 52, and the surface 80a may be visible when the protrusion 80 is viewed in the above-described direction. For example, as shown in FIG. 14, the protrusion 80 may have a configuration in which the protrusion 80 protrudes from both end edges 80b and 80c of the protrusion 80 in the width direction of the ridge 52 toward the second region 73. In this configuration, the surface 80a has a protruding edge 80d between the end edge 80b and the end edge 80c in the width direction of the ridge 52, and has a first surface 80a1 and a second surface 80a2 on both sides of the protruding edge 80d in the width direction of the ridge 52. In a case where the protrusion 80 has such a configuration, the crossflow flowing along the second region 73 toward the protrusion 80 (in a direction of an arrow F₂) collides with the protruding edge 80d to be divided into flows (arrows G₂ and H₂) on both sides of the protruding edge 80d. One of the divided crossflows (arrow G₂) flows along the first surface 80a1, and the other (arrow H2) flows along the second surface 80a2, so that the crossflows flow into the recovery spaces 53 and 53 on both sides of the ridge 52. As a result, since the crossflow flowing into a space between the first region 72 and the inner surface 34a of the blade wall 34 is reduced, the influence of the crossflow on the flow of the cooling medium jetted from the opening 58 in the first region 72 can be weakened.

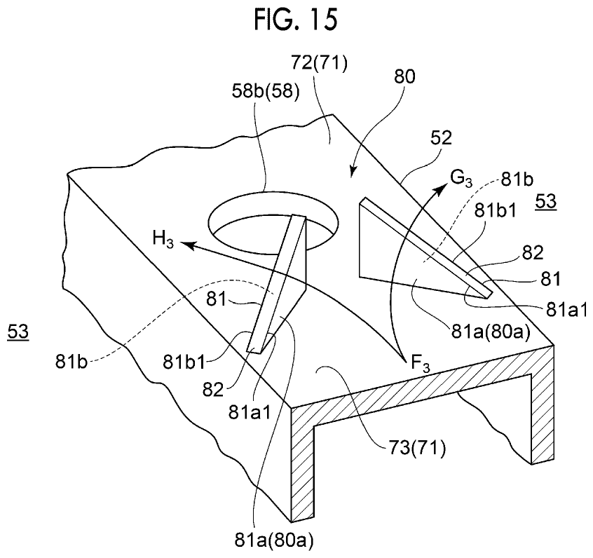

Further, for example, as shown in FIG. 15, the protrusion 80 may be composed of two plates 81 and 81 having a shape of a right triangle. Each plate 81 includes a front surface 81a that is one surface of the right triangle and a back surface 81b that is the other surface of the right triangle, and an inclined surface 82 is defined between hypotenuses 81a1 and 81b1 on each of the front surface 81a and the back surface 81b of each plate 81. The two plates 81 and 81 are disposed such that each inclined surface 82 faces the second region 73 in the longitudinal direction of the ridge 52 and a distance between the two inclined surfaces 82 and 82 in the width direction of the ridge 52 is reduced in a direction from the second region 73 to the first region 72 when the protrusion 80 is viewed toward the facing surface 71. In this configuration, the front surface 81a of each plate 81 corresponds to the surface 80a. In a case where the protrusion 80 has such a configuration, the crossflow flowing along the second region 73 toward the protrusion 80 (in a direction of an arrow F3) is a flow (vortex) that crosses each plate 81, and flows into the recovery spaces 53 and 53 on both sides of the ridge 52. As a result, since the crossflow flowing into a space between the first region 72 and the inner surface 34a of the blade wall 34 is reduced, the influence of the crossflow on the flow of the cooling medium jetted from the opening 58 in the first region 72 can be weakened.

In a case where the protrusion 80 is provided on the premise of the configuration of Embodiment 1 and the modification example thereof, the protrusion 80 may be provided in the first region 72 or the second region 73. In a case where the angle θ₁ (see FIG. 7) is relatively small and the angle θ₂ (see FIG. 7) is a relatively large value for the boundary region 74, the protrusion 80 can be provided in the boundary region 74. In addition, the protrusion 80 can be provided in the boundary region 74 with both the angle θ₁ (see FIG. 7) and the angle θ₂ (see FIG. 7) set to 180° without the premise of the configuration of Embodiment 1 and the modification example thereof.

### Embodiment 6

Next, the turbine blade according to Embodiment 6 of the present disclosure will be described. Although Embodiment 6 is described as a configuration independent of the configurations of Embodiments 1 to 5, Embodiment 6 may have a configuration described below on the premise of the configurations of Embodiments 1 to 5 and the modification examples thereof. Further, in Embodiment 6, the same components as those in Embodiments 1 to 5 are designated by the same reference signs, and the detailed descriptions thereof will be omitted.

### <Configuration of Turbine Blade According to Embodiment 6 of Present Disclosure>

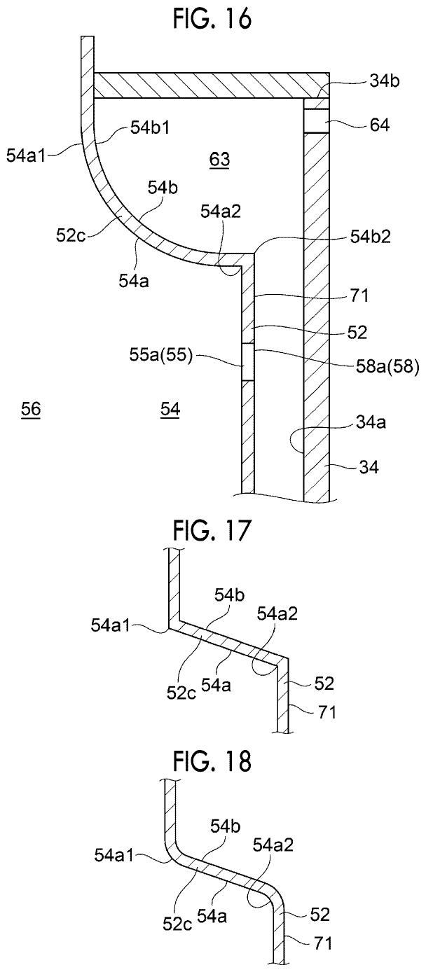

As shown in FIG. 16, an internal end surface 54a is a surface within the flow path 54 inside the ridge 52 facing the recovery flow path 63 when viewed in the longitudinal direction of the ridge 52. The internal end surface 54a includes a first end edge 54a1 that is an end edge on the internal cavity 56 side and a second end edge 54a2 that is an end edge on the facing surface 71 side in a direction from the internal cavity 56 toward the facing surface 71. The internal end surface 54a is configured to be away from the discharge hole 64 in the longitudinal direction of the ridge 52 toward the second end edge 54a2 from the first end edge 54a1.

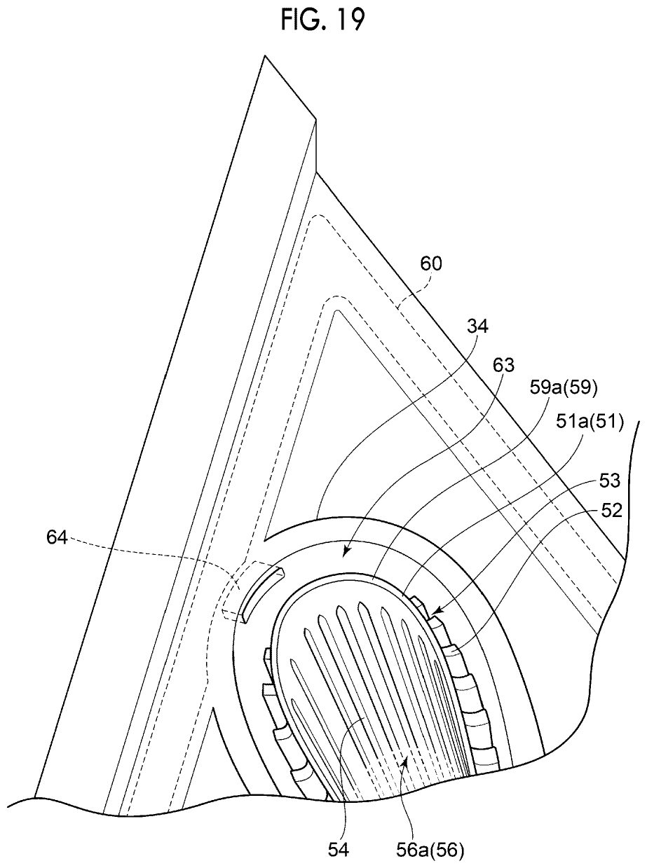

The internal end surface 54a may have any form as long as the internal end surface 54a has such a feature. For example, as shown in FIG. 16, the internal end surface 54a may be a curved surface that is curved to protrude toward a side opposite to the recovery flow path 63 in the longitudinal direction of the ridge 52. In a case where the internal end surface 54a is such a curved surface, an outer surface 54b of the end portion 52c of the ridge 52 may also be a curved surface that is curved to protrude in a direction away from the discharge hole 64 in the longitudinal direction of the ridge 52, as in the internal end surface 54a. In a case where the outer surface 54b is such a curved surface, in Embodiment 6, in a case where at least the second connection edge 54b2 out of the first connection edge 54b1 and the second connection edge 54b2 is located at a position away from the tip-side edge 34b toward the hub-side edge 34c (see FIG. 2) of the blade wall 34 in the longitudinal direction of the ridge 52, the recovery flow path 63 is formed between the tip-side edge 34b and the end portion 52c in the longitudinal direction. In addition, as shown in FIG. 17, the internal end surface 54a may be a flat surface from the first end edge 54a1 to the second end edge 54a2, or as shown in FIG. 18, may be a form in which the cross section of each of the first end edge 54a1 and the second end edge 54a2 is changed to a curved shape with respect to the configuration of FIG. 17.

### <Cooling Operation of Blade Wall in Turbine Blade According to Embodiment 6 of Present Disclosure

The cooling operation of the blade wall in the turbine blade according to Embodiment 6 of the present disclosure is essentially the same as in Embodiment 1. In Embodiment 1, as shown in FIG. 7, since the internal end surface 54a is perpendicular to the longitudinal direction of the ridge 52, a boundary between the inner surface 56a defining the internal cavity 56 and the internal end surface 54a, that is, the first end edge 54a1, has a right-angled cross-sectional shape. Therefore, when the cooling medium flows from the internal cavity 56 into the flow path 54, flow separation is likely to occur at the first end edge 54a1. On the other hand, in the configurations of FIGS. 16 and 18 of Embodiment 6, since the first end edge 54a1 has a smooth curved shape, the flow separation is unlikely to occur at the first end edge 54a1 when the cooling medium flows from the internal cavity 56 into the flow path 54. In addition, in the configuration of FIG. 17, since the angle of the cross-sectional shape of the first end edge 54 a1 is larger than 90°, the flow separation is unlikely to occur at the first end edge 54a1 when the cooling medium flows from the internal cavity 56 into the flow path 54.

As described above, since the concern of the flow separation of the flow of the cooling medium when the cooling medium flows from the internal cavity 56 into the flow path 54 can be reduced, the concern of the reduction in the flow rate of the cooling medium jetted from the opening 58 of the cooling hole 55 can be reduced, and the adverse effect on the cooling effect of the blade wall 34 can be suppressed.

### <Modification Example of Turbine Blade According to Embodiments 1 to 6 of Present Disclosure>

The configuration in which the recovery flow path 63 is formed in the blade wall 34 is not limited to a case where the ridges 52 have the forms of Embodiments 1 to 6. Even in a case where the ridges 52 are provided in a configuration other than the forms of Embodiments 1 to 6, the cooling medium that has cooled the blade wall 34 can be made to easily flow out from the inside of the blade wall 34 by providing the recovery flow path 63. In addition, the configurations of Embodiments 2 to 5 are not necessarily premised on the configuration in which the first region 72 protrudes toward the inner surface 34a of the blade wall 34 more than the second region 73 on the facing surface 71 of each ridge 52, and the configurations can also be established in a configuration in which the first region 72 and the second region 73 are present on the same plane without the first region 72 protruding toward the inner surface 34a of the blade wall 34 more than the second region 73.

In FIG. 4, the supply path 62 that communicates the discharge hole 64 with the supply port 61 is shown to have a certain length, but the length is arbitrary, and the length may be shorter than the length of the supply path 62 shown in FIG. 4, or as shown in FIG. 19, for example, the supply path 62 may not be provided and the discharge hole 64 and the supply port 61 may be directly connected to each other.

For example, contents described in each of the above-described embodiments are understood as follows.

[1] A turbine blade according to one aspect is a turbine blade (stator vane 24/rotor blade 26) including
a blade wall (34), and
an insert (51) that is inserted into a space (50) formed inside the blade wall (34), in which
an internal cavity (56) that communicates with an outside of the turbine blade (24/26) is formed inside an insert body portion (59) of the insert (51),
a plurality of ridges (52) that protrude toward an inner surface (34a) of the blade wall (34) and that have facing surfaces (71) facing the inner surface (34a) of the blade wall (34) are formed on an outer surface (59a1 and 59b1) of the insert body portion (59),
each of the plurality of ridges (52) is formed with
   a flow path (54) that communicates with the internal cavity (56), and
   a plurality of cooling holes (55) that communicate with the flow path (54), are open at the facing surface (71), and are arranged along a longitudinal direction of each of the plurality of ridges (52),
a recovery space (53) is defined between two adjacent ridges (55 and 55) of the plurality of ridges (52),
a recovery flow path (63) that communicates with the recovery space (53) is defined between the outer surface (59a1 and 59b1) of the insert body portion (59) and the inner surface (34a) of the blade wall (34) and, in the longitudinal direction, between a hub-side edge (34c) of the blade wall (34) and an end portion (52d) of the ridge (52) on a hub side, or between a tip-side edge (34b) of the blade wall (34) and an end portion (52c) of the ridge (52) on a tip side, and
a discharge hole (64) that communicates the recovery flow path (63) with the outside of the turbine blade (24/26) is formed in the blade wall (34).

According to the turbine blade of the present disclosure, since the cooling medium flowing through each recovery space converges in the recovery flow path and flows out from the recovery flow path through the discharge hole, the cooling medium that has cooled the blade wall can be made to easily flow out from the inside of the blade wall.

[2] A turbine blade according to another aspect is the turbine blade according to [1], in which
an outer surface (54b) of an end portion (52c and 52d) facing the recovery flow path (63) among two end portions (52c and 52d) of each of the plurality of ridges (52) in the longitudinal direction includes
   a first connection edge (54b1) connected to the outer surface (59a1 and 59b1) of the insert body portion (59), and
   a second connection edge (54b2) connected to the facing surface (71),
at least the second connection edge (54b2) out of the first connection edge (54b1) and the second connection edge (54b2) is located, in the longitudinal direction, at a position away from the hub-side edge (34c) of the blade wall (34) toward the tip-side edge (34b) of the blade wall (34) or at a position away from the tip-side edge (34b) toward the hub-side edge (34c), and
the outer surface (54b) is a surface that is curved to be recessed toward a side opposite to the recovery flow path (63) in the longitudinal direction.

According to such a configuration, the recovery flow path is formed between the tip-side edge and the end portion or between the hub-side edge and the end portion in the longitudinal direction of the ridge.

[3] A turbine blade according to still another aspect is the turbine blade according to [1], in which
an outer surface (54b) of an end portion (52c and 52d) facing the recovery flow path (63) among two end portions (52c and 52d) of each of the plurality of ridges (52) in the longitudinal direction includes
   a first connection edge (54b1) connected to the outer surface (59al and 59b1) of the insert body portion (59), and
   a second connection edge (54b2) connected to the facing surface (71),
at least the second connection edge (54b2) out of the first connection edge (54b1) and the second connection edge (54b2) is located, in the longitudinal direction, at a position away from the hub-side edge (34c) of the blade wall (34) toward the tip-side edge (34b) of the blade wall (34) or at a position away from the tip-side edge (34b) toward the hub-side edge (34c), and
the outer surface (54b) is a flat surface.

According to such a configuration, the recovery flow path is formed between the tip-side edge and the end portion or between the hub-side edge and the end portion in the longitudinal direction of the ridge.

[4] A turbine blade according to still another aspect is the turbine blade according to any one of [1] to [3], in which
a shroud peripheral flow path (60) that extends along a peripheral edge of an outer shroud (38) or an inner shroud (40) is formed in one of the outer shroud (38) or the inner shroud (40) provided at each of the tip-side edge (34b) and the hub-side edge (34c) of the blade wall (34), and
the recovery flow path (63) communicates with the shroud peripheral flow path (60) through the discharge hole (64).

According to such a configuration, since the cooling medium flowing out from the recovery flow path through the discharge hole flows through the shroud peripheral flow path and then flows out from the shroud peripheral flow path to the outside of the stator vane through the discharge port formed in the shroud peripheral flow path, the cooling medium that has cooled the blade wall can be made to easily flow out from the inside of the blade wall.

[5] A turbine blade according to still another aspect is the turbine blade according to any one of [1] to [4], in which,
in each of the plurality of ridges (52), when a cooling hole (55) formed at a position closest to the discharge hole (64) in the longitudinal direction among the plurality of cooling holes (55) is defined as a first cooling hole (55a), a first region (72) of the facing surface (71) including an opening (58a) of at least the first cooling hole (55a) protrudes toward the inner surface (34a) of the blade wall (34) more than a second region (73) of the facing surface (71) including an opening (58) of another cooling hole (55).

According to the turbine blade of the present disclosure, the crossflow may locally increase in a region close to the discharge hole in the longitudinal direction of each of the plurality of ridges, but the first region of the facing surface including the opening of the first cooling hole formed at a position closest to the discharge hole among the plurality of cooling holes formed in each of the plurality of ridges protrudes toward the inner surface of the blade wall more than the second region of the facing surface including the opening of another cooling hole. As a result, since the cooling medium jetted from the opening in the first region can collide with the inner surface of the blade wall before the flow of the cooling medium is deflected by the crossflow, the adverse effect of the locally large crossflow on the cooling effect of the blade wall of the turbine blade can be suppressed.

[6] A turbine blade according to another aspect is the turbine blade according to any one of [1] to [5], in which
in each of the plurality of ridges (52), when a surface within the flow path (54) facing the recovery flow path (63) when viewed in the longitudinal direction is defined as an internal end surface (54a),
the internal end surface (54a) includes a first end edge (54a1) that is an end edge on an internal cavity (56) side and a second end edge (54a2) that is an end edge on a facing surface (71) side in a direction from the internal cavity (56) toward the facing surface (71), and
the internal end surface (54a) is configured to be away from the discharge hole (64) in the longitudinal direction from the first end edge (54a1) toward the second end edge (54a2).

In a case where the internal end surface is perpendicular to the longitudinal direction of the ridge, when the cooling medium flowing through the internal cavity flows into the flow path in the ridge, the flow separation of the flow of the cooling medium is likely to occur at a boundary portion between the internal cavity and the flow path, the flow of the cooling medium in the flow path is disturbed, and there is a concern that the flow rate of the cooling medium jetted from the opening of the cooling hole may be reduced. On the other hand, according to the configuration of , since the concern of the flow separation of the flow of the cooling medium when the cooling medium flows from the internal cavity into the flow path can be reduced, the concern of the reduction in the flow rate of the cooling medium jetted from the opening of the cooling hole can be reduced, and the adverse effect on the cooling effect of the blade wall of the turbine blade can be suppressed.

[7] A turbine blade according to still another aspect is the turbine blade according to [5], in which
in each of the plurality of ridges (52), a boundary region (74) connecting the first region (72) and the second region (73) is formed, and when an angle formed by the boundary region (74) with respect to the first region (72) is denoted by θ₁, and an angle formed by the boundary region (74) with respect to the second region (73) is denoted by θ₂,
180°<θ₁≤270° and 90°≤θ₂<180° are satisfied.

According to such a configuration, the crossflow changes the flow direction when the crossflow flows from the second region into the first region. As a result, since the influence of the crossflow on the cooling medium jetted from the opening in the first region can be suppressed, the adverse effect of the locally large crossflow on the cooling effect of the blade wall of the turbine blade can be suppressed.

[8] A turbine blade according to still another aspect is the turbine blade according to any one of [1] to [7], in which
when a cooling hole formed at a position closest to the discharge hole (64) in the longitudinal direction among the plurality of cooling holes (55) is defined as a first cooling hole (55a), each of the plurality of ridges (52) includes
   a first region (72) of the facing surface (71) including an opening (58a) of at least the first cooling hole (55a), and
   a second region (73) of the facing surface (71) including an opening (58) of another cooling hole (55), and
in each of the plurality of ridge protrusion portions (52), a protrusion (80) including a surface (80a) facing the first region (72) when viewed from the second region (73) in the longitudinal direction is provided between an opening (58b) formed at a position farthest from the discharge hole (64) in the longitudinal direction among at least one opening (58) in the first region (72) and an opening (58c) formed at a position closest to the discharge hole (64) in the longitudinal direction among at least one opening (58) in the second region (73).

According to such a configuration, the crossflow changes the flow direction when the crossflow flows from the second region into the first region by colliding with the protrusion. As a result, since the influence of the crossflow on the cooling medium jetted from the opening in the first region can be suppressed, the adverse effect of the locally large crossflow on the cooling effect of the blade wall of the turbine blade can be suppressed.

[9] A turbine blade according to still another aspect is the turbine blade according to any one of [1] to [8], in which
when a cooling hole formed at a position closest to the discharge hole (64) in the longitudinal direction among the plurality of cooling holes (55) is defined as a first cooling hole (55a), each of the plurality of ridges (52) includes
   a first region (72) of the facing surface (71) including an opening (58a) of at least the first cooling hole (55a), and
   a second region (73) of the facing surface (71) including an opening (58) of another cooling hole (55), and
an opening area of the opening (58) in the first region (72) is larger than an opening area of the opening (58) in the second region (73).

According to such a configuration, since the flow rate of the cooling medium jetted from the opening in the first region is larger than the flow rate of the cooling medium jetted from the opening in the second region, even in a case where there is a concern that the crossflow flowing between the first region and the inner surface is locally large and the cooling efficiency of the blade wall may be reduced, the concern of the reduction in the cooling efficiency can be compensated for by the increase in the flow rate of the cooling medium jetted toward the inner surface facing the first region. In addition, as a result, since the flow of the cooling medium jetted from the opening in the first region has a larger cross-sectional area of the flow cut in a direction orthogonal to the flow direction than the flow of the cooling medium jetted from the opening in the second region and thus is less likely to be deflected by the crossflow, the adverse effect of the locally large crossflow on the cooling effect of the blade wall of the turbine blade can be suppressed.

[10] A turbine blade according to still another aspect is the turbine blade according to any one of [1] to [9], in which
when a cooling hole formed at a position closest to the discharge hole (64) in the longitudinal direction among the plurality of cooling holes (55) is defined as a first cooling hole (55a), each of the plurality of ridges (52) includes
   a first region (72) of the facing surface (71) including an opening (58a) of at least the first cooling hole (55a), and
   a second region (73) of the facing surface (71) including an opening (58) of another cooling hole (55), and
when a length of each of the plurality of ridges (52) in a direction orthogonal to the longitudinal direction is defined as a width,
in each of the plurality of ridges (52), a width (W₁) in a portion including the first region (72) is smaller than a width (W₂) in a portion including the second region (73).

According to such a configuration, a width of the recovery space between the first regions of the adjacent ridges is larger than a width of the recovery space between the second regions of the adjacent ridges. As a result, since the crossflow flowing between the first region and the inner surface of the blade wall is likely to flow into the recovery space, the adverse effect of the locally large crossflow on the cooling effect of the blade wall of the turbine blade can be suppressed.

[11] A turbine blade according to still another aspect is the turbine blade according to any one of [1] to [10], in which
in each of the plurality of ridges (52), both end edges (71c and 71d) of the facing surface (71) in a direction orthogonal to the longitudinal direction are chamfered.

According to such a configuration, since the crossflow is likely to flow into the recovery space as compared with a case where both end edges of the facing surface are not chamfered, the adverse effect of the locally large crossflow on the cooling effect of the blade wall of the turbine blade can be suppressed.

[12] A turbine blade according to still another aspect is the turbine blade according to any one of [1] to [10], in which
when a cooling hole formed at a position closest to the discharge hole (64) in the longitudinal direction among the plurality of cooling holes (55) is defined as a first cooling hole (55a), each of the plurality of ridges (52) includes
   a first region (72) of the facing surface (71) including an opening (58a) of at least the first cooling hole (55a), and
   a second region (73) of the facing surface (71) including an opening (58) of another cooling hole (55), and
both end edges (71c and 71d) of the facing surface (71) in a direction orthogonal to the longitudinal direction in the first region (72) of each of the plurality of ridges (52) are chamfered.

According to such a configuration, since the crossflow is likely to flow into the recovery space as compared with a case where both end edges of the first region of the facing surface are not chamfered, the adverse effect of the locally large crossflow on the cooling effect of the blade wall of the turbine blade can be suppressed.

[13] A turbine blade according to still another aspect is the turbine blade according to [7], in which
the boundary region (74) protrudes from both end edges (74c and 74d) of the boundary region (74) in a direction orthogonal to the longitudinal direction toward the second region (72).

According to such a configuration, the crossflow flows along the boundary region and flows into the recovery spaces on both sides of the ridge. As a result, since the crossflow flowing into the space between the first region and the inner surface of the blade wall is reduced, the adverse effect of the locally large crossflow on the cooling effect of the blade wall of the turbine blade can be suppressed.

### REFERENCE SIGNS LIST

24: stator vane (turbine blade)
26: rotor blade (turbine blade)
34: blade wall
34a: inner surface (of blade wall)
34b: tip-side edge (of blade wall)
34c: hub-side edge (of blade wall)
38: outer shroud
40: inner shroud
50: space
51: insert
52: ridge
52c: end portion (of ridge)
52d: end portion (of ridge)
53: recovery space
54: flow path
54a: internal end surface
54a1: first end edge (of internal end surface)
54a2: second end edge (of internal end surface)
54b: outer surface (of end portion of ridge)
54b1: first connection edge (of outer surface)
54b2: second connection edge (of outer surface)
55: cooling hole
55a: first cooling hole
56: internal cavity
58: opening
58a: opening (of first cooling hole)
58b: opening (formed at position farthest from discharge hole)
58c: opening (formed at position closest to discharge hole)
59: insert body portion
59a1: outer surface (of insert body portion)
59b1: outer surface (of insert body portion)
60: shroud peripheral flow path
63: recovery flow path
64: discharge hole
71: facing surface
72: first region
73: second region
74: boundary region
74c: end edge (of boundary region)
74d: end edge (of boundary region)
80: protrusion
80a: surface (of protrusion)

1. A turbine blade or a stator van comprising:
a blade wall; and
an insert that is inserted into a space formed inside the blade wall, wherein
an internal cavity that communicates with an outside of the turbine blade or the stator vane is formed inside an insert body portion of the insert,
a plurality of ridges that protrude toward an inner surface of the blade wall and that have facing surfaces facing the inner surface of the blade wall are formed on an outer surface of the insert body portion,
each of the plurality of ridges is formed with
a flow path that communicates with the internal cavity, and
a plurality of cooling holes that communicate with the flow path, are open at the facing surface, and are arranged along a longitudinal direction of each of the plurality of ridges,
a recovery space is defined between two adjacent ridges of the plurality of ridges,
a recovery flow path that communicates with the recovery space is defined between the outer surface of the insert body portion and the inner surface of the blade wall and, in the longitudinal direction, between a hub-side edge of the blade wall and an end portion of the ridge on a hub side, or between a tip-side edge of the blade wall and an end portion of the ridge on a tip side, and
a discharge hole that communicates the recovery flow path with the outside of the turbine blade or the stator vane is formed in the blade wall.

2. The turbine blade or the stator vane according to claim 1, wherein
an outer surface of an end portion facing the recovery flow path among two end portions of each of the plurality of ridges in the longitudinal direction includes
a first connection edge connected to the outer surface of the insert body portion, and
a second connection edge connected to the facing surface,
at least the second connection edge out of the first connection edge and the second connection edge is located, in the longitudinal direction, at a position away from the hub-side edge of the blade wall toward the tip-side edge of the blade wall or at a position away from the tip-side edge toward the hub-side edge, and
the outer surface is a surface that is curved to be recessed toward a side opposite to the recovery flow path in the longitudinal direction.

3. The turbine blade or the stator vane according to claim 1, wherein
an outer surface of an end portion facing the recovery flow path among two end portions of each of the plurality of ridges in the longitudinal direction includes
a first connection edge connected to the outer surface of the insert body portion, and
a second connection edge connected to the facing surface,
at least the second connection edge out of the first connection edge and the second connection edge is located, in the longitudinal direction, at a position away from the hub-side edge of the blade wall toward the tip-side edge of the blade wall or at a position away from the tip-side edge toward the hub-side edge, and the outer surface is a flat surface.

4. The turbine blade or the stator vane according to claim 1, wherein
a shroud peripheral flow path that extends along a peripheral edge of an outer shroud or an inner shroud is formed in one of the outer shroud or the inner shroud provided at each of the tip-side edge and the hub-side edge of the blade wall, and
the recovery flow path communicates with the shroud peripheral flow path through the discharge hole.

5. The turbine blade or the stator vane according to claim 1, wherein
in each of the plurality of ridges, when a cooling hole formed at a position closest to the discharge hole in the longitudinal direction among the plurality of cooling holes is defined as a first cooling hole, a first region of the facing surface including an opening of at least the first cooling hole protrudes toward the inner surface of the blade wall more than a second region of the facing surface including an opening of another cooling hole.

6. The turbine blade or the stator vane according to claim 1, wherein
in each of the plurality of ridges, when a surface within the flow path facing the recovery flow path when viewed in the longitudinal direction is defined as an internal end surface,
the internal end surface includes a first end edge that is an end edge on an internal cavity side and a second end edge that is an end edge on a facing surface side in a direction from the internal cavity toward the facing surface, and
the internal end surface is configured to be away from the discharge hole in the longitudinal direction from the first end edge toward the second end edge.

7. The turbine blade or the stator vane according to claim 5, wherein
in each of the plurality of ridges, a boundary region connecting the first region and the second region is formed, and when an angle formed by the boundary region with respect to the first region is denoted by θ₁, and an angle formed by the boundary region with respect to the second region is denoted by θ₂,
180°<θ₁≤270° and 90°≤θ₂<180° are satisfied.

8. The turbine blade or the stator vane according to claim 1, wherein
when a cooling hole formed at a position closest to the discharge hole in the longitudinal direction among the plurality of cooling holes is defined as a first cooling hole, each of the plurality of ridges includes
a first region of the facing surface including an opening of at least the first cooling hole, and
a second region of the facing surface including an opening of another cooling hole, and
in each of the plurality of ridges, a protrusion including a surface facing the first region when viewed from the second region in the longitudinal direction is provided between an opening formed at a position farthest from the discharge hole in the longitudinal direction among at least one opening in the first region and an opening formed at a position closest to the discharge hole in the longitudinal direction among at least one opening in the second region.

9. The turbine blade or the stator vane according to claim 1, wherein
when a cooling hole formed at a position closest to the discharge hole in the longitudinal direction among the plurality of cooling holes is defined as a first cooling hole, each of the plurality of ridges includes
a first region of the facing surface including an opening of at least the first cooling hole, and
a second region of the facing surface including an opening of another cooling hole, and
an opening area of the opening in the first region is larger than an opening area of the opening in the second region.

10. The turbine blade or the stator vane according to claim 1, wherein
when a cooling hole formed at a position closest to the discharge hole in the longitudinal direction among the plurality of cooling holes is defined as a first cooling hole, each of the plurality of ridges includes
a first region of the facing surface including an opening of at least the first cooling hole, and
a second region of the facing surface including an opening of another cooling hole, and
when a length of each of the plurality of ridges in a direction orthogonal to the longitudinal direction is defined as a width,
in each of the plurality of ridges, a width in a portion including the first region is smaller than a width in a portion including the second region.

11. The turbine blade or the stator vane according to claim 1, wherein
in each of the plurality of ridges, both end edges of the facing surface in a direction orthogonal to the longitudinal direction are chamfered.

12. The turbine blade or the stator vane according to claim 1, wherein
when a cooling hole formed at a position closest to the discharge hole in the longitudinal direction among the plurality of cooling holes is defined as a first cooling hole, each of the plurality of ridges includes
a first region of the facing surface including an opening of at least the first cooling hole, and
a second region of the facing surface including an opening of another cooling hole, and
both end edges of the facing surface in a direction orthogonal to the longitudinal direction in the first region of each of the plurality of ridges are chamfered.

13. The turbine blade or the stator vane according to claim 7, wherein
the boundary region protrudes from both end edges of the boundary region in a direction orthogonal to the longitudinal direction toward the second region.
